(19) United States
(12) Patent Application Publication
(10) Pub. No.: US 2017/0151688 A1
(43) Pub. Date: Jun. 1, 2017

(54) METHOD OF MANUFACTURING A CORRUGATED WOOD ELEMENT, A CORRUGATED WOOD ELEMENT AND ITS USES

(71) Applicant: Wood Innovations Ltd., Eschen (LI)

(72) Inventors: Thomas Eckstein, Dresden (DE); Achim Moeller, Dresden (DE)

(73) Assignee: Wood Innovations Ltd., Eschen (LI)

(21) Appl. No.: 15/300,415

(22) PCT Filed: Mar. 31, 2015
(86) PCT No.: PCT/EP2015/000702

§ 371 Date: Sep. 29, 2016

(30) Foreign Application Priority Data
Apr. 2, 2014 (EP) 14001220.4

(51) Int. Cl. B27D 1/06; B32B 7/12; B32B 21/02; E04C 2/32; A43B 13/08; A43B 17/12; E04C 2/16; B32B 3/28; B32B 21/13

(52) U.S. Cl. CPC B27D 1/06; B32B 3/28; B32B 7/12; B32B 21/02; B32B 21/13; A43B 13/08; A43B 17/12; E04C 2/16; E04C 2/322; B32B 2307/102; B32B 2307/304; B32B 2307/51; B32B 2605/00; B32B 2607/02

(57) ABSTRACT

Method of making a wavy wood element (B) from a wood element •(A), wherein the method comprises at least steps (H1) to (H4): •(H1) providing a wood element (A), which comprises fibers and lignin on or between said fibers; •(H2) heating the wood element (A) to a temperature which is sufficient to soften or melt at least a part of the lignin; •(H3) deforming the wood element heated in step (H2) such that a wavy wood element (B) is formed; •(H4) cooling the wood element deformed in step (H3); characterized in that the deforming in step (H3) is performed such that the ratio of the wave height to the thickness of the wavy wood element (B) equals or is more than 2:1; wherein the term “thickness” signifies the shortest distance between an upper side and the respective lower side of the wavy wood element (B), and the term “wave height” signifies the shortest distance between two imaginary planes which run in parallel to one another between which the wavy wood element (B) may be arranged such that the waves are positioned between said planes; and wherein the wood element (A) consists of unglued wood or unglued wood fibers.

### FIELD OF THE INVENTION

The present invention relates to a method of making a wavy wood element, to the wood element as such, to the use of the wood element, to a core layer comprising the wood element, and to a multi-layer composite, which comprises said core layer, preferably a lightweight building board. The invention further relates to a method of making the core layer and the multi-layer composite.

### BACKGROUND OF THE INVENTION

It is known to use composite materials for making multi-layer composites which have a relatively high mechanical stability in comparison to their weight. Multi-layer composites of this type are used, for example, in the form of lightweight building boards. The intermediate layer of such multi-layer composites can be designed in a wavy form.

CH 254025 relates to a multi-layer composite comprising two cover plates and a core layer in-between, wherein the core layer comprises at least one layer of folded veneer.

DE 42 01 201 relates to a wooden semi-finished product or finished product made of planar elements. The planar elements can be zigzag-shaped. These wood elements are made from industrial waste from chipboards and fiberboards, i.e. glued wood or glued wood fibers. The wood elements may be further plasticized by heating and/or wetting.

DE 10 2008 022 806 relates to a lightweight building board comprising a layer of wavy wood veneer. The waves may be zigzag-shaped. The layer of wavy wood veneer is formed by a wood veneer which has a linear reduction in the thickness of the wood veneer, which initially is flat wherein the linearity of the reduction allows folding, respectively bending wood veneer at predetermined positions.

DE 10 2008 022 805 relates to a lightweight building board comprising a wavy veneer board as intermediate layer. The intermediate layer consists of glued waves.

BE 547 811 relates to a multi-layer composite which comprises wavy wood elements. The wavy wood elements are made by directing wood between two profile rollers.

EP 1 923 209 relates to a lightweight building composite board comprising an intermediate layer which is zigzag-shaped. The intermediate layer consists of a wood material, in particular a chipboard, oriented strand board (OSB) panel or fiberboard, i.e. glued woods or wood fibers.

WO 2013/164100 A1 relates to a core layer and a multi-layer composite which comprises the core layer, wherein the core layer is construed from zigzag-shaped wood elements. The zigzag-shaped wood elements are made by folding a platelet-shaped wood element, preferably by directing a platelet-shaped wood element between a quickly rotating pair of profile rollers.

Wavy wood elements are further known from WO 2009/067344. Said wood elements are made by heating a planar veneer, optionally by heating with steam, wherein lignin being contained in the wood element is softened. The resulting pre-treated veneer is directed between two profiled rollers, wherein the rollers imprint a wavy profile into the veneer. Subsequently, said wavy profile is removed by planing such as sanding. Thereby, a decorative veneer is created in which the veneer has a grain direction which is changed compared to the planar wood element. Like the planar element, it does not have wave crests and wave troughs.

Multi-layer composites having wavy wood elements share a core layer having a loosened structure. When applying force perpendicular to the surface of the multi-layer composite, same provides for a damping effect since the core layer allows at least partially for compressing.

However, compression may lead to an irreversible deforming of the core layer, if elements in the core layer break or are damaged under the impact of force, or the core layer is extensively flattened by pressing, or the glue lines/adhesive joints are damaged.

### OBJECTS OF THE INVENTION

However, compression may lead to an irreversible deforming of the core layer, if It is an object of the present invention to provide wood elements suitable for a core layer, to provide a core layer comprising said wood elements, and to provide a multi-layer composite comprising the core layer, which has/have an improved load capacity, and wherein the core layer, respectively the multi-layer composite, has/have a density as low as possible. Furthermore, core layer and multi-layer composite comprising the core layer should be cost-effectively producible, preferably by using raw materials of low quality, in particular wood raw material having low quality.

### SUMMARY OF THE INVENTION

According to the invention, said object is achieved by using heat-treated non-planar wood elements for making the core layer, wherein said heat-treated non-planar wood elements are preferably provided in a wavy form.

The Invention takes advantage of a method for making a non-planar wood element (B) from a planar or non-planar wood element (A), wherein the method comprises at least steps (H1) to (H4):
(H1) providing a planar or non-planar wood element (A), which comprises fibers and lignin on or between said fibers, preferably wherein the wood element (A) is an unglued wood element;
(H2) heating the wood element (A) to a temperature which is sufficient to soften or melt at least a portion of the lignin;
(H3) deforming the wood element heated in step (H2) such that a non-planar wood element (B) is formed;
(H4) cooling the heated wood element (A) deformed in step (H3), respectively the formed wood element (B), to a temperature below the softening temperature or melt temperature of the lignin.

In one embodiment, steps (H2) and (H3) may be performed simultaneously.

The produced non-planar wood element preferably is a wavy wood element. Such wood elements provide for an excellent load capacity such that they may be used as or for a loosened core layer, respectively in multi-layer composites having a loosened core layer, which in turn allow for a high load capacity at a relatively low density.

According to a first aspect, the invention relates to a method of making a wavy wood element (B) from a planar or non-planar wood element (A), wherein the method comprises at least steps (H1) to (H4):
(H1) providing a planar or non-planar wood element (A), which comprises fibers and lignin on or between said fibers;
(H2) heating the wood element (A) to a temperature which is sufficient to soften or to melt at least a part of the lignin; preferably, the temperature is at least 80° C.; it is particularly preferred that the temperature is in the range of from 80° C. to 400° C.;
(H3) deforming the wood element heated in step (H2) such that a wavy wood element (B) is formed;
(H4) cooling the wood element deformed in step (H3);
   characterized in that the deforming in step (H3) is performed such that the ratio of the wave height to the thickness of the wavy wood element (B) is 2:1 or is more than 2:1;
   wherein the term “thickness” signifies the shortest distance between an upper side and the respective lower side of the wavy wood element (B), and the term “wave height” signifies the shortest distance between two imaginary planes which run in parallel to one another, between which the wavy wood element (B) may be arranged such that the waves are positioned between said planes;
   and wherein the wood element (A) consists of unglued wood or unglued wood fibers.

In one embodiment, in step (H2), the wood element (A) is heated to a temperature in the range of from 100° C. to 380° C., or to a temperature in the range of from 120° C. to 360° C., or to a temperature in the range of 150° C. to 350° C.; or wood element (A) is heated to a temperature in the range of from 230° C. to 400° C., or from 240 to 400° C., or from 250 to 400° C., or from 260 to 400° C., or from 230° C. to 350° C., or from 240 to 350° C., or from 250 to 350° C., or from 260 to 350° C.; and/or

wherein in step (H4) the wood element deformed in step (H3) is cooled down to ambient temperature, preferably to a temperature in the range of from 0° C. to 40° C., further preferred to 10° C. to 30° C.

In one embodiment, deforming in step (H3) is performed by means of a profile tool such that the wave of the wavy wood element (B) comprises one positive or one negative half-wave only.

In one embodiment, deforming in step (H3) is performed by means of a profile tool such that the wave of the wavy wood element (B) comprises at least one positive and one negative half-wave.

In one embodiment, deforming in step (H3) is performed by means of a profile tool such that the wave of the wavy wood element (B) comprises at least two positive half-waves but no negative half-wave.

In one embodiment, deforming in step (H3) is performed by means of a profile tool such that the wavy wood element (B) comprises in longitudinal section repeating units in the form of a trapezoid; or repeating units in the form of a sine function.

In a further embodiment, the deforming in step (H3) is performed by means of a profile tool such that the wavy wood element (B) has at least partially the form of a trapezoidal wave, or at least partially the form of sine wave, or at least partially the form of a rectangular wave, or at least partially the form of a triangle wave, or at least partially the form of a sawtooth wave, or wherein the wavy wood element (B) has at least partially at least two different of these forms.

In a further embodiment, in step (H1) a wood element (A) is utilized, the fibers of which have a preferred direction, and the deforming in step (H3) is performed such that

the fiber direction of the wavy wood element (B) does not run in parallel to a wave trough or a wave crest of the wave; or
the fiber direction of the wavy wood element (B) runs perpendicularly to a wave trough or wave crest of the wave.

In a further embodiment, the ratio of the wave height to thickness is in the range of equal or more than 2.0:1 to 70:1, or equal or more than 2.0:1 to 60:1, or equal or more than 2.0:1 to 50:1, or equal or more than 2.0:1 to 40:1, or equal or more than 2.0:1 to 30:1. In a preferred embodiment, the ratio of wave height to thickness is in the range of equal or more than 2.0:1 to 15:1, more preferred 3:1 to 10:1, still more preferred 4:1 to 8:1 or 5:1 to 6:1.

In a further embodiment, the thickness of the wavy wood element (B) is in the range of from 0.1 mm to 5 mm and the wave height is in the range of from 1 mm to 20 mm; or the thickness of the wavy wood element (B) is in the range of from 0.2 mm to 3.5 mm and the wave height is in the range of from 2 mm to 12 mm; or the thickness of the wavy wood element (B) is in the range of from 0.2 mm to 2 mm and the wave height is in the range of from 2 mm to 8 mm.

In a further embodiment, the method additionally comprises at least one of the following steps (H3.1), (H3.2), (H3.3), (H5) and/or (H6):
(H3.1) directing the wood element (A) heated in step (H2) between at least one pair of profile rollers, the rollers thereof rotate in opposite direction;
(H3.2) drying the deformed wood element obtained in step (H3);
(H3.3) deforming a wave trough or a wave crest of a wave of the wavy wood element (B) such that in the wave trough and/or in the wave crest a deepening is at least partially formed, preferably a fold;
(H5) crushing the wood element obtained in step (H4);
(H6) sieving the wood element obtained in step (H4) or step (H5).

In one embodiment, wood element (A) is a veneer.

In one embodiment, wood element (A) is an OSB chip having a length of more than 50 mm and a thickness of less than 2 mm.

In one embodiment, wood element (A) is an OSB chip having a length of from 75 to 100 mm, a width of from 5 to 30 mm, and a thickness of from 0.3 to 0.65 mm; or

having a length of from 75 to 150 mm, a width of from 15 to 25 mm, and a thickness of from 0.3 to 0.7 mm; or
having a length of from 75 to 150 mm, a width of from 10 to 35 mm, and a thickness of from 0.6 to 0.8 mm.

In one embodiment, wood element (A) is an OSB chip having a length of from 40 to 80 mm, and a width of from 4 to 10 mm, wherein the ratio of length to width is at least 5:1.

In a second aspect, the invention relates to a wavy wood element, the surface of which is at least partially coated with lignin or comprises at least partially lignin, characterized in that it is obtainable by a method as defined in the first aspect.

Furthermore, the invention relates to a wavy wood element, the surface of which is at least partially coated with lignin or comprises at least lignin, characterized in that the ratio of the wave height to thickness of the wavy wood elements is equal or more than 2:1; wherein the term “thickness” signifies the shortest distance between an upper side and the respective lower side of the wavy wood element, and the term “wave height” signifies the shortest distance between two imaginary planes which run in parallel to one another, between which the wavy wood element may be arranged such that the waves are positioned between said planes; and wherein the wood element consists of unglued wood or unglued wood fibers.

In one embodiment, the wave of the wavy wood element comprises a positive-half wave, respectively a negative half-wave, only.

In one embodiment, the wave of the wavy wood element comprises at least one positive and one negative half-wave.

In one embodiment, the wave of the wavy wood element comprises at least two positive half-waves but no negative half-wave.

In one embodiment, the wavy wood element comprises at least two adjoining platelet-shaped regions, which form between them a common edge, wherein
(a) said platelet-shaped regions are planar regions, and the edge between said planar regions is a planar region; or
(b) said platelet-shaped regions are curved regions, and the edge between said planar regions is a curved region; or
(c) said platelet-shaped regions are curved regions, and the edge between said curved regions is a straight line; or
(d) said platelet-shaped regions are curved regions, and the edge between said curved regions is a planar region.

In one embodiment, the wave of the wavy wood element
(a) has at least partially the form of a trapezoidal wave; or has in longitudinal section at least partially the form of a trapezoidal wave or comprises repeating units of a trapezoid; or
(b) has at least partially the form of a sine wave; or has in longitudinal section at least partially the form of a sine wave or comprises repeating units of a sine function; or
(c) has at least partially the form of a rectangular wave; or has in longitudinal section at least partially the form of a rectangular wave or comprises repeating units of a rectangle; or
(d) has at least partially the form of a triangle wave; or has in longitudinal section at least partially the form of a triangle wave or comprises repeating units of a triangle; or
(e) has at least partially the form of a sawtooth wave; or has in longitudinal section at least partially the form of a sawtooth wave or comprises repeating units of a sawtooth.

In a third aspect, the invention relates to the use of a wood element as defined in this second aspect,

as shoe insole, or as a part of a shoe sole, or for making a shoe insole, or for making a shoe sole; or
as wall paper or for making a wall paper; or
as core layer or for making a core layer; or
for making a multi-layer composite, in particular a lightweight building board; or
for sound insulation; or
for heat insulation.

In a fourth aspect, the invention relates to a core layer at least comprising a wavy wood element as defined in the second aspect; or

a core layer comprising a multitude of wood elements as defined in the second aspect, which may be the same or may be different from one another, wherein in the core layer also regions may be present having a higher or lower density of wood elements compared to other regions of the core layer.

In one embodiment, the core layer comprises at least two wavy wood elements, which may be the same or which may be different from one another, wherein a wave trough of a wavy wood element contacts a wave crest of another wavy wood element, wherein wave trough and wave crest are connected at the point of contact by means of an adhesive.

In one embodiment, a wave trough of a wavy wood element crosses a wave crest of another wavy wood element in an angle which is different from zero.

In a fifth aspect, the invention relates to a multi-layer composite, in particular a lightweight building board, wherein the multi-layer composite comprises at least one cover layer and at least one wavy wood element as defined in the second aspect, which is connected to the cover layer by means of an adhesive; or

wherein the multi-layer composite comprises at least one cover layer and a core layer as defined in the fourth aspect, wherein the core layer is connected to the cover layer by means of an adhesive.

In a sixth aspect, the invention relates to the use of a core layer as defined in the fourth aspect, or to the use of a multi-layer composite as defined in the fifth aspect, for making furniture, doors and gates, panels, floors, shelves, packaging for transportation, indoor extensions, as well as in vehicle and ship construction, for fields of the constructive timber construction, and for sound and heat insulation.

### BRIEF DESCRIPTION OF THE FIGURES

In the Figures show:

FIG. 1 a side view of a wood element according to the invention having a uniform amplitude of the waves, wherein the wave height W signifies the shortest distance between two imaginary planes which run in parallel to one another, between which the wavy wood element may be arranged such that the waves are positioned between said planes, wherein the ratio of wave height W to thickness d of the wavy wood element is 2:1 or is more than 2:1;

FIG. 1a the wood element from FIG. 1 in a perspective view; the dashed lines symbolize the fiber direction, which runs perpendicular to a wave trough, respectively a wave crest.

FIG. 2 a side view of a further wood element according to the invention having different amplitudes of the waves, wherein the wave height W signifies the shortest distance between two imaginary planes which run in parallel to one another, between which the wavy wood element may be arranged such that the waves are positioned between said planes, wherein the ratio of the wave height W to thickness d of the wavy wood element is 2:1 or is more than 2:1;

FIG. 3 a longitudinal section of a wavy wood element 1 according to the invention, wherein wavy wood element 1 has an edge in the form of a planar region 1′, and wherein the platelet-shaped regions 20 and 30 of wavy wood element 1 are planar regions;

FIG. 4 a longitudinal section of a wavy wood element 2 according to the invention, wherein wavy wood element 2 has an edge in the form of a convex region 2′, and wherein the platelet-shaped regions 20 and 30 are curved regions, respectively;

FIG. 5 a longitudinal section of a wavy wood element 3 according to the invention, wherein wavy wood element 3 has an edge in the form of a straight line 3′, and wherein the platelet-shaped regions 20 and 30 are curved regions, respectively;

FIG. 6 a longitudinal section of a wavy wood element 4 according to the invention, wherein wavy wood element 4 has an edge in the form of a planar region 4′, and wherein the platelet-shaped regions 20 and 30 are curved regions, respectively;

FIG. 7 a longitudinal section of a wavy wood element 5 according to the invention, wherein wavy wood element 5 comprises repeating units of wavy wood element 1 of FIG. 3; the wave comprises at least one positive half-wave and at least one negative half-wave: the wave may be characterized as a trapezoidal wave;

FIG. 8 a longitudinal section of a wavy wood element 6 according to the invention, wherein wavy wood element 6 comprises repeating units of wavy wood element 2 of FIG. 4; the wave comprises at least one positive half-wave and at least one negative half-wave; the wave may be characterized as a sine wave;

FIG. 9 a longitudinal section of a wavy wood element 7 according to the invention, wherein wavy wood element 7 comprises repeating units of wavy wood element 3 of FIG. 5; the wave comprises at least one positive half-wave and at least one negative half-wave;

FIG. 10 a longitudinal section of a wavy wood element 8 according to the invention, wherein wavy wood element 8 comprises repeating units of wavy wood element 4 of FIG. 6; the wave comprises at least one positive half-wave and at least one negative half-wave;

FIG. 11 a longitudinal section of a wavy wood element 9 according to the invention, wherein wavy wood element 9 comprises repeating units of wavy wood element 1 of FIG. 3; the wave comprises at least two positive half-waves, but no negative half-wave;

FIG. 12 a longitudinal section of a wavy wood element 10 according to the invention, wherein wavy wood element 10 comprises repeating units of wavy wood element 2 of FIG. 4; the wave comprises at least two positive half-waves, but no negative half-wave;

FIG. 13 a longitudinal section of a wavy wood element 11 according to the invention, wherein wavy wood element 11 comprises repeating units of wavy wood element 3 of FIG. 5; the wave comprises at least two positive half-waves, but no negative half-wave;

FIG. 14 a longitudinal section of a wavy wood element 12 according to the invention, wherein wavy wood element 12 comprises repeating units of wavy wood element 4 of FIG. 6; the wave comprises at least two positive half-waves, but no negative half-wave;

FIG. 15 an arrangement of wavy wood elements 13 in a core layer of a multi-layer composite according to the invention. The wood elements 13 are randomly arranged. The contact area 70 between a wave trough 40 of one wood element with a wave crest 50 of another wood element is point-shaped. Wave trough 40 of a wavy wood element crosses a wave crest 50 of another wavy wood element in an angle which is different from zero.

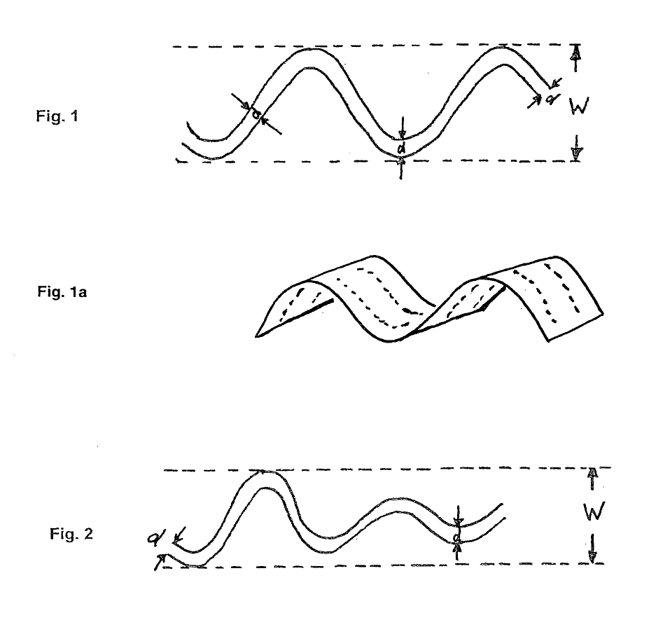

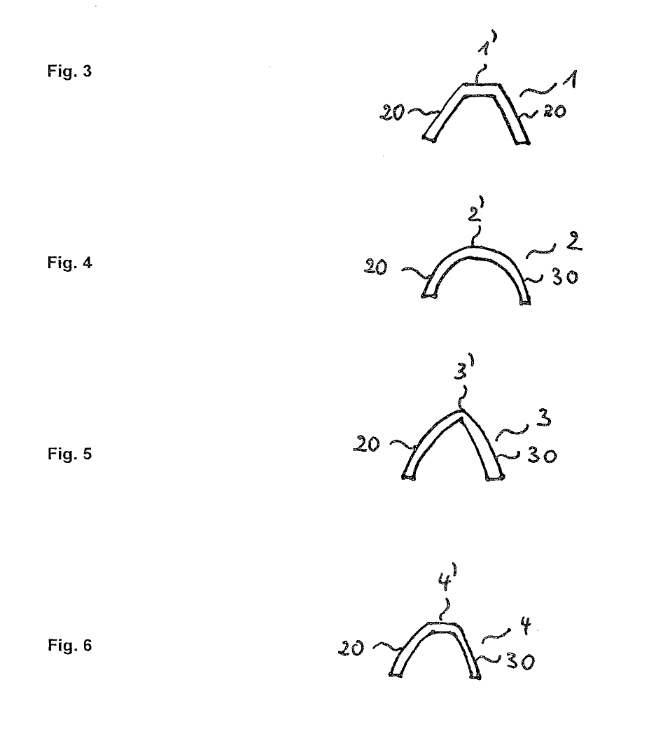

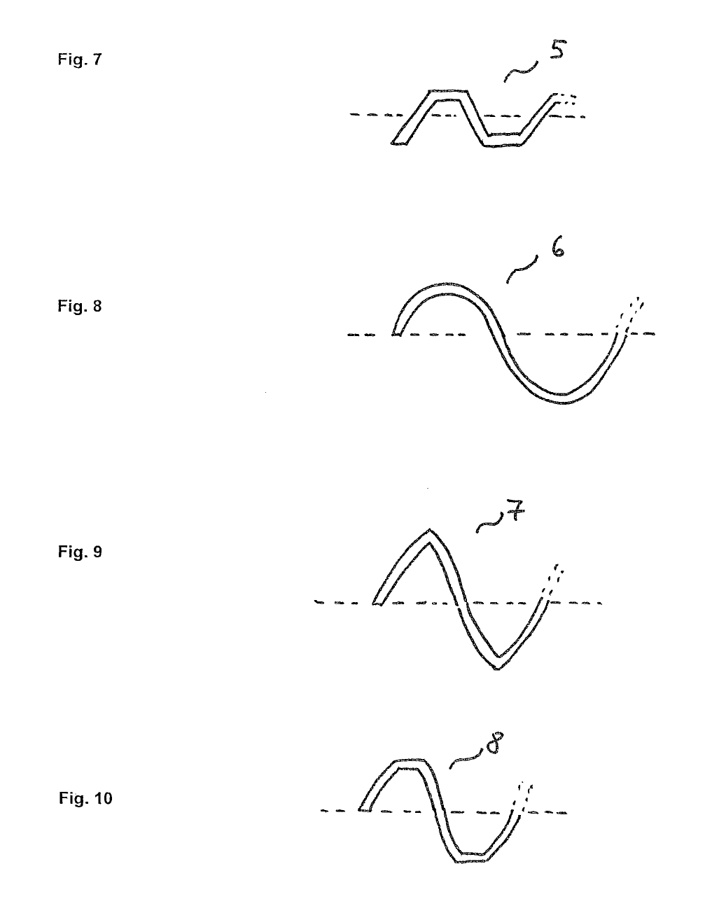

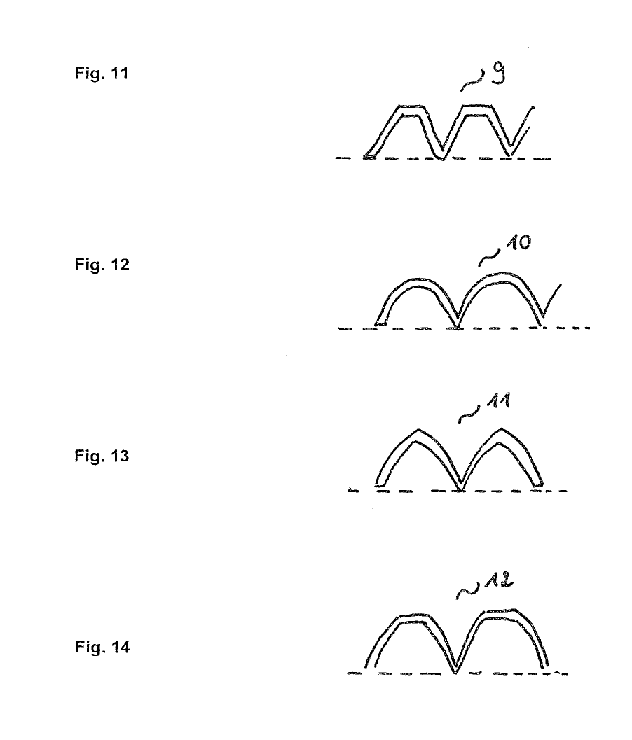

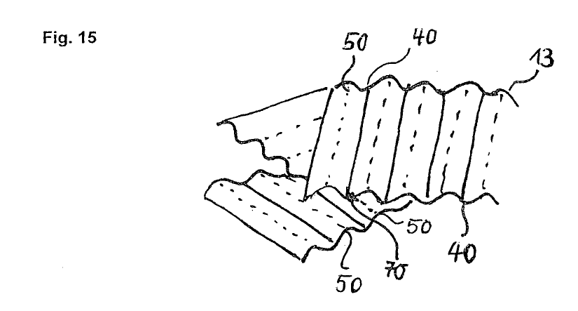

### DETAILED DESCRIPTION OF THE INVENTION

The following terms in quotation marks are defined in the meaning of the invention.

### First Aspect of the Invention: Method of Making a Wavy Wood Element (B) According to the Invention

In a first aspect, the invention relates to a method for making a wavy wood element (B) from a planar or non-planar wood element (A), wherein the method comprises at least steps (H1) to H4):
(H1) providing a planar or non-planar wood element (A), which comprises fibers and lignin on or between the fibers; preferably, the planar or non-planar wood element (A) does not comprise an adhesive;
(H2) heating the wood element (A) to a temperature which is sufficient to soften or melt at least a part of the lignin;
(H3) deforming the wood element heated in step (H2) such that a wavy wood element (B) is formed;
(H4) cooling the wood element deformed in (H3);
   characterized in that the deforming in step (H3) is performed such that the ratio of the wave height to the thickness of the wavy wood element (B) is 2:1 or is more than 2:1.

### Step (H1)

According to the invention, a planar or non-planar wood element is provided in step (H1).

The term “planar” signifies that all points or faces of the wood element are within one plane.

The term “non-planar” signifies that not all points or faces of the wood element are in one plane. Accordingly, the non-planar wood element may also comprise at least one region which is planar.

The term “region” signifies a certain areal or region of the wood element.

The term “wood element” signifies an object or article made from wood. Said wood preferably comprises long fibers, wherein lignin is arranged between and on said fibers. Preferably, the length of the fibers corresponds to the length of the wood element.

Preferably, the wood element (A) is planar.

In a preferred embodiment, a planar or non-planar wood element (A) is used in the method according to the invention, wherein wood element (A) unglued, i.e. it does not comprise an adhesive.

The term “unglued” signifies that the wood element (A) is not assembled from glued wood, or glued woods, or glued fibers, strands or chips. Thus, the wood element (A) does not comprise an adhesive or glue which is typically used in the wood industry for gluing wood. Known adhesives of this type are based on glutin, casein, urea-formaldehyde, phenol-formaldehyde, resorcinol-formaldehyde, polyvinyl acetate, polyurethane.

In one embodiment, the term “unglued” signifies that the wood element (A) is not assembled from glued wood, or glued woods, or glued fibers, strands or chips, and does not contain any added chemical such as a chemical for plastification or water-repellency.

Accordingly, in this embodiment of the method according to the invention, a wood element (A) is utilized in step (H1), preferably in the form of a veneer, preferably peeled veneer or sliced veneer. Typically, the thickness of the veneer is in the range of from 0.1 to 5 mm, more preferred 0.2 to 4 mm or 0.2 to 2 mm.

It is also possible to utilize a wood element (A) which is made by sawing unglued wood.

In a further embodiment, it is also possible to utilize a wood element (A), which is obtained by machining wood in known machines, for example machining log wood in knife ring flakers. A wood element made by machining log would in a knife ring flaker is also known under the term “OSB chip” or “OSB strand”.

The term “OSB chip” or “OSB strand” further signifies that said wood strands or wood chips have a predetermined length of more than 50 mm and a thickness of less than 2 mm.

In a preferred embodiment, said strands or chips have a length of from 75 to 100 mm, a width of from 5 to 30 mm, and a thickness of from 0.3 to 0.65 mm.

In a further preferred embodiment, said strands or chips have a length of from 75 to 150 mm, a width of from 15 to 25 mm, and a thickness of from 0.3 to 0.7 mm.

In a further preferred embodiment, said strands or chips have a length of from 75 to 150 mm, a width of from 10 to 35 mm, and a thickness of from 0.6 to 0.8 mm.

In a further preferred embodiment, said strands or chips have a length of from 40 to 80 mm, a width of from 4 to 10 mm, wherein the ratio of length to width is at least 5:1.

Furthermore, the wood element (A) is not restricted to a certain type of wood. It may be made from any wood, for example from wood of a broad-leafed tree or a coniferous tree. Furthermore, the wood element (A) is not restricted to a certain quality of the raw material or/and dimensions. This also means that for making a multi-layer composite the wood elements are not restricted to a sheet material having relatively great dimensions, but preferably relatively “small” spreadable wood elements may be utilized, which may be randomly arranged. The term “small” is defined in the following in connection with the dimensions of the wood element. These relatively small elements tolerate defectives, since defective elements, in which, for example, the waves are not pronounced, or the waves are partially destroyed, may be sieved out, or may be targetedly admixed to the multi-layer composite. Also, a multi-layer composite of the present invention differs in said feature from known multi-layer composites as, for example, disclosed in BE 547 811, DE 10 2008 022 805, EP 1 923 209, DE 10 2008 022 806, and CH 254 025, since relatively large sheet-like wood elements are utilized in said documents. However, in a less preferred embodiment, the method according to the invention allows also the manufacture of sheet-like wood elements.

In the method according to the invention also wood elements (A) may be utilized, which are provided in different dimensions and in different sizes. This preferably may be necessary if OSB chips are utilized in the method according to the invention since the variances in the dimensions of said chips may be in a relatively great range. Also, wood elements (A) from wood waste and/or low-grade raw wood qualities, provided said wood wastes are unglued.

Preferably, the wood element (B) is single-layered.

The term “single layered” signifies that the wood element (A) provided in step (H1) has only one layer or one stack of wood. In particular, the term “single layered” signifies that the wood element does not consist of different layers of wood which are fixed by means of an adhesive or glue.

As is known, the fibers of such a wood element (A), i.e. an unglued wood element, have a preferred direction, i.e. they are anisotropically structured.

However, this does not exclude that the fiber direction may sectionally change due to a curved growth of the wood, due to fiber twists, or due to a wavy grain. This does not mean that this is attributed to a rotation of the fiber direction of up to 90°, however, it is possible that the fiber direction is rotated up to 30°.

Thus, the term “preferred direction” includes that the directions of individual fibers may deviate up to 30° from the preferred direction.

Contrary to the wood elements (B) made according to the invention, for example, the wood elements disclosed in DE 42 01 201 have no preferred direction of the wood fibers. This is discussed in more detail below in the section “The wood elements (B) made according to the method according to the invention are distinctly different from those discussed in the section BACKGROUND OF THE INVENTION”.

Since the fibers of the wood element (A) which is utilized in step (H1) is anisotropically structured, thus have a preferred direction, the fibers in step (H3) also have a preferred direction after deformation. This preferred direction is developed in the form of a wave. Thus, the wave has a preferred direction in wave direction. This preferred direction may be the same or may be different from that of the wood element provided in step (H1). Preferably, the fiber direction, respectively the preferred direction, is the same.

Accordingly, in one embodiment, the method according to the invention is also characterized in that the fibers of the wood elements (A) and (B) have a preferred direction, respectively, which may be the same or which may be different from one another. Preferably, the preferred direction of the fibers in (A) and (B) is the same.

### Step (H2)

According to the invention, the wood element (A) which is provided in step (H1) and which is utilized in step (H2) is heated. The heating is performed at a temperature which is sufficient to soften or to melt at least a part of the lignin which is on and between the fibers of the wood element (A).

Preferably, in step (H2), the wood element (A) is heated to a temperature of at least 80° C., in particular to a temperature in the range of from 80° C. to 400° C., further preferably in a range of from 100° C. to 380° C., more preferred in a range of from 120° C. to 360° C., and still more preferred in a range of from 150° C. to 350° C. In a particularly preferred embodiment, wood element (A) is heated to a temperature in the range of from 230° C. to 400° C., or from 240° C. to 400° C., or from 250° C. to 400° C., or from 260° C. to 400° C., 230° C. to 350° C., or from 240° C. to 350° C., or from 250° C. to 350° C., or from 260° C. to 350° C.

If relatively high temperatures are used in step (H2), the heating period should not be too long in order to avoid damages, such as smoldering or burning. Such heating may also cause decomposition of the wood's cellulose, hemicellulose and/or lignin, which may negatively affect the load capacity of wood element (B). Vice versa, at relatively low temperatures, a longer heating period may be necessary. Preferably, the heating period is in the range of from 0.005 s to 50 s, further preferred in the range of from 0.005 s to 10 s, more preferred in the range of from 0.005 s to 5 s, still more preferred in the range of from 0.01 to 2 s.

Heating may be performed by means of a suitable device or a suitable heat carrier. Preferably, electrically heated devices are utilized. Heating by means of hot air or hot steam is likewise possible. Heating by means of a suitable oil is likewise conceivable.

From experience, heating by hot steam is possible up to a maximum of 200° C. When utilizing electrically heated devices, also higher temperatures may be achieved, preferably a temperature in the range of from 230° C. to 400° C., or from 240° C. to 400° C., or from 250° C. to 400° C., or from 260° C. to 400° C., or from 230° C. to 350° C., or from 240° C. to 350° C., or from 250° C. to 350° C., or from 260° C. to 350° C.

In one embodiment, the heating in step (H2) is performed without feeding water or steam.

Without being bound by theory, it is assumed that by means of the heating of the lignin, which is on and between the fibers of the wood element (A), i.e. the wood's own lignin, said lignin softens or melts at least partially. Then, the at least partially softened or molten lignin may reach by means of diffusion at least partially the surface and may arrive at the surface of the deformed wood element. When cooling down according to step (H4), said lignin is solidified. Thereby, the wood element (B) made according to the method according to the invention is at least partially coated with lignin. This effect may be visually monitored by means of the naked eye since the surface of the wood element (B) in general has a higher gloss compared to the surface of the wood element (A) provided in step (H1).

It is further assumed that said lignin layer is substantially responsible for the stability of the wood element (B) made according to the invention, which is superior compared to the stability of the non-planar wood elements known from the prior art.

The inventors of the present invention have discovered that heating of wood element (A) in step (H2) facilitates the subsequent or simultaneous deforming of the heated wood element in step (H3), and results in a wavy wood element (B) in which elastic recovery is suppressed, respectively reduced. In sum, a wavy wood element is obtained having improved stability and load capacity.

Furthermore, the subsequent deformation in step (H3) is performed such that at the turning points of the wave fibers as few as possible break or are damaged since the stability of the wood element (B) would be restricted. Fiber breakage, however, cannot be completely excluded since different wood types may also react differently with regard to deformation in step (H3) due to, for example, different density quality. Fiber breakage may also be due to sections in the wood element stemming from branches, to a sectional change of the fiber direction due to a curved growth of the wood, due to fiber twists, or due to a wavy grain.

In one embodiment, prior to step (H2), additional lignin may be added to the wood element (A), i.e. lignin not stemming from said wood. When applying temperature according to step (H2), also said lignin softens or melts at least partially, wherein the wood element (B) made according to the invention is at least partially additionally coated with lignin. This added lignin can thus impart an additional stability to the resulting wood element (B).

The term “the wood's own lignin” thus signifies that lignin stems from the wood of the wood element (A) from which the wood element (B) was made.

The term “lignin not stemming from said wood” signifies that said lignin does not stem from the wood from which the wood element (B) is made. Thus, the wood element (B) is additionally coated with lignin which does not stem from said wood.

### Step H3

According to the invention, the wood element (A) heated in step (H2) is deformed in step (H3). This deforming is performed such that according to the invention a wood element results in the form of a wavy wood element (B).

The term “wavy” is synonymously used to the term “wavily developed” or “corrugated”.

The term “wavy” means a wave which has at least one wave crest (crest) or a wave trough or a wave crest and a wave trough.

If the wave has a wave crest or a wave trough only, the wave may also be termed as a positive half-wave or negative half-wave.

The terms “positive half-wave” and “negative half-wave” are used in a mathemathical meaning.

Preferably, deforming in step (H3) is performed by means of a profile tool.

The term “profile tool” signifies that roundings and/or channels are in the tool or on the tool. Said roundings and/or channels result in a deformation if the planar wood element is exposed to the profile tool. Thereby, the planar wood element can be deformed without applying pressure as well as under pressure.

Suitable profile tools are known from the prior art, e.g. from DE 42 01 201 or WO 2009/067344. These profile tools may be adapted to the conditions required for making the wood element (B) according to the invention such that the ratio of the wave height to the thickness in the generated wood elements is 2:1 or more than 2:1. Preferably, said profile tools are additionally heated, namely then if steps (H2) and (H3) are to be simultaneously performed.

In a preferred embodiment, the wood element (A) heated in step (H2) is exposed in step (H3) to at least one pair of profile rollers.

In a preferred embodiment, deforming in step (H3) comprises step (H3.1):
(H3.1) directing the wood element (A) heated in step (H2) between at least a pair of profile rollers, the rollers of which rotate in opposite direction.

Preferably, at least one of the rollers of the at least one pair of profile rollers is heated, further preferably electrically heated. Thus steps (H2) and (H3) may be performed simultaneously.

In one embodiment, also several pairs of profile rollers may be employed which are arranged in series.

Preferably, the at least one pair of profile rollers utilized in step (H3.1) or another profile tool which is suitable for deforming is developed such that the wood element (A) is wavily developed. Then, it comprises at least one wave crest (crest) or a wave trough or a wave crest and a wave trough.

In one embodiment, said wavy wood element comprises at least two adjoining platelet-shaped regions, which form between them a common edge.

In one embodiment, said platelet-shaped regions are planar regions, and the edge between said planar regions is a planar region.

In another embodiment, said platelet-shaped regions are curved regions, and the edge between said planar regions is a curved region.

In another embodiment, said platelet-shaped regions are curved regions, and the edge between said curved regions is a straight line.

In another embodiment, said platelet-shaped regions are curved regions, and the edge between said curved regions is a planar region.

In one embodiment, the wavy wood element comprises a positive-half wave, respectively a negative half-wave, only.

In one embodiment, the wavy wood element comprises at least a positive and a negative half-wave.

In another embodiment, the wavy wood element comprises at least two positive half-waves, but no negative half-waves.

In one embodiment, the form of the wave has at least partially the form of a trapezoidal wave. In another embodiment, the wavy wood element has in longitudinal section the form of a trapezoidal wave or comprises repeating units of a trapezoid.

In one embodiment, the form of the wave has at least partially the form of a sine wave. In another embodiment, the wavy wood element has in longitudinal section at least partially the form of a sine wave or comprises repeating units of a sine function or sine wave.

In another embodiment, the form of the wave has at least partially the form of a rectangular wave. In another embodiment, the wavy wood element has in longitudinal section at least partially the form of a rectangular wave or comprises repeating units of a rectangle.

In another embodiment, the form of the wave has at least partially the form of a triangle wave. In another embodiment, the wavy wood element has in longitudinal section at least partially the form of a triangle wave or comprises repeating units of a triangle.

In a further embodiment, the form of the wave has at least partially the form of a sawtooth wave. In another embodiment, the wavy wood element has in longitudinal section at least partially the form of a sawtooth wave or comprises repeating units of a sawtooth.

In the embodiments of a trapezoidal wave, a rectangular wave, a triangle wave, or a sawtooth wave, deforming is performed such that the non-planar wood element comprises at least one planar region.

According to the invention, thus the wavy wood element (B) may comprise at least one planar region, wherein the form of said wood element is not restricted to the trapezoidal wave, a rectangular wave, a triangle wave, or a sawtooth wave.

The deformation in step (H3) may also be performed such that the wavy wood element (B) comprises at least partially at least two different of these forms.

In one embodiment, the wood element (B) comprises at least four wave crests and wave troughs, i.e. four complete waves.

If in step (H2) a wood element (A) is utilized, the fibers of which have a preferred direction, then the deforming in step (H3) is preferably performed such that the deforming is not performed in parallel to the fiber direction of the wood element (A). Thus, also the direction of the fibers does not run in parallel to a wave trough or wave crest of the wood element (B) formed in the deformation.

The term “in parallel to a wave trough or a wave crest” hereby signifies that the fiber direction runs in parallel to an imaginary line which is on the wave crest (crest) or wave trough, and which represents the shortest distance between the side borders of the wave trough or wave crest.

Thus, the deformation is performed in a transverse direction relative to the fiber direction, respectively to the preferred direction of the fibers.

In a preferred embodiment, the deforming in step (H3) is performed such that same is performed in a perpendicular or vertical direction relative to the fiber direction of the wood element (A). Thus, the direction of the fibers runs perpendicularly to a wave trough or a wave crest in the wood element (B) formed in the deformation.

The term “perpendicular to a wave trough or a wave crest” means perpendicular or vertical to an imaginary line which is on the wave crest (crest) or wave trough of the wood element (B), and which represents the shortest distance between the side borders of the wave trough or wave crest.

The term “perpendicular to a wave trough or a wave crest” also signifies that a deviation in an angle approximately up to 30° is possible.

In a preferred embodiment, the deformation in step (H3) is performed such that the longitudinal direction runs perpendicularly to a wave trough or a wave crest.

By means of the preferred deformation transversely or perpendicularly to the preferred direction of the fibers, the stability of the wood element (B) made according to the invention is further improved.

If namely the deformation in step (H3) runs in parallel to the preferred direction of the fibers, as a consequence, deforming may result in damage, for example the element may be flattened, or the wood element even may break. This may also occur if such deformed wood elements are loaded with a weight.

Such damages may not occur or may only occur to a minor extent if deforming is performed transversely to the fiber direction or perpendicularly to the fiber direction. Thus, the stability of such a wood element is improved since damages parallel to the fiber direction do not occur or do only occur to a minor extent.

Steps (H2) and (H3) may be performed subsequently or also simultaneously.

In a preferred embodiment, steps (H2) and (H3) are performed simultaneously.

Deforming in step (H3) according to the invention is performed such that the ratio of the wave height to the thickness of the wavy wood element (B) is at least 2:1, preferably more than 2:1.

The term “wave height” signifies the sum of the deflection between a wave crest and a wave trough from an imaginary base line, which runs between the wave crest and the wave trough. This also means that the wave height may be defined as the shortest distance between two imaginary planes which run in parallel to one another, between which the wavy wood element (A) can be arranged such that the waves are positioned between said planes.

The term “thickness” signifies the shortest distance between an upper side and the respective lower side of the wavy wood element (B).

In one embodiment, the ratio of the wave height to thickness is in the range of from equal or more than 2.0:1 to 70:1, or from equal or more than 2.0:1 to 60:1, or from equal or more than 2.0:1 to 50:1, or from equal or more than 2.0:1 to 40:1, or from equal or more than 2.0:1 to 30:1. In a preferred embodiment, the ratio of wave height to thickness is in the range of from equal or more than 2.0:1 to 15:1, more preferred from 3:1 to 10:1, still more preferred from 4:1 to 8:1 or from 5:1 to 6:1.

Contrary to the wood elements prepared according to the methods according to the invention, the wavy, wood elements disclosed in WO 2009/067344 have a ratio of wave height to thickness of less than 2:1, since otherwise the wave crests and wave troughs may not be removed without destroying the decorative wood element to be formed. This is explained in more detail below in the section “The wood elements (B) made according to the method according to the invention are different from the wood elements discussed in the section BACKGROUND OF THE INVENTION”.

Preferably, the thickness of a wood element (B) in the region of the wave crest and in the region of the wave trough does not differ by more than 20% and, if the wood element has a partially planar region, the planar region has a thickness in the range of the thickness of the wave crest and/or wave trough.

### Step (H4)

According to the invention, the wood element deformed in step (H3) is cooled down in step (H4), preferably to a temperature where the lignin solidifies or is solidified completely or at least partially. Thereby, the wavy wood element (B) is obtained and is physically present. Preferably, it is cooled down to ambient temperature, preferably to a temperature in the range of from 0° C. to 40° C., further preferred of from 10° C. to 30° C.

Cooling may be performed by means of ambient air and/or by means of a blower, i.e. by directly blowing the wood element produced in step (H3), preferably by blowing with air. The produced wood element (B) can then preferably be stored and may be fed thereafter to an application.

The wood element (B) made according to the method according to the invention is not restricted with respect to its length and width.

Preferably, a wood element (A) is employed in the method according to the invention which is dimensioned such that the ratio of length to width in the wood element (B) is in the range of from 2:1 to 50:1, further preferred in the range of from 2:1 to 40:1.

In one embodiment, the product from length×width is in the range of from 10 mm×5 mm to 3,000 mm×1,000 mm.

Preferably, relatively large wood elements (B) which preferably are sheet-like developed are subjected to a crushing step. This is explained in more detail below in the section “Optional Method Steps”.

Relatively small wood elements (B) preferably have a product of length×width in the range of from 10 mm×5 mm to 200 mm×100 mm, further preferred of from 10 mm×5 mm to 100 mm×50 mm, further preferred of from 10 mm×5 mm to 50 mm×25 mm.

The term “length” signifies the shortest distance between the beginning and end of the wood element (B) in longitudinal direction of the wood element (B), preferably measured in fiber direction.

The term “width” signifies the shortest distance between the side margin in transverse direction relative to the longitudinal direction of the wood element (B), preferably measured transversely relative to the fiber direction.

Preferably, a wood element (A) is utilized in the method according to the invention which is dimensioned such that the wavy wood element (B) obtained according to the method according to the invention has a thickness in the range of from 0.1 mm to 5 mm, preferably of from 0.2 mm to 3.5 mm, further preferred of from 0.2 mm to 2 mm.

Preferably, deforming in step (H3) is performed such that also the profile of the profile tool is selected such that the wave height of the wood element (B) is in the range of from 1 mm to 20 mm, preferably of from 2 mm to 12 mm, more preferred of from 2 mm to 8 mm.

In a preferred embodiment, the thickness of the wavy wood element (B) is in the range of from 0.1 mm to 5 mm and the wave height is in the range of from 1 mm to 20 mm, wherein the ratio of the wave height to thickness of the wavy wood element (B) is more than 2:1.

In a particularly preferred embodiment, the thickness of the wavy wood element (B) is in the range of from 0.2 mm to 3.5 mm and the wave height is in the range of from 2 mm to 12 mm, wherein the ratio of the thickness to the wave height of the wavy wood element (B) is more than 2:1.

In a further particularly preferred embodiment, the thickness of the wavy wood element (B) is in the range of from 0.2 mm to 2 mm and the wave height is in the range of from 2 mm to 8 mm, wherein the ratio of the weight height to the thickness of the wavy wood element (B) is more than 2:1.

The wavy wood elements made according to the method according to the invention preferably have a bulk density in the range of from 40 kg/m³ to 125 kg/m³, more preferred in the range of from 45 kg/m³ to 100 kg/m³, still more preferred in the range of from 50 kg/m³ to 80 kg/m³.

### Optional Method Steps

In a further embodiment, the method according to the invention may comprise additional method steps.

In one embodiment, prior to carrying out step (H2), the wood element (A) or the wood from which said wood element (A) is made, may be subjected to a treatment with water, and thus a wet wood element (A) may be utilized in the method according to the invention.

The term “wet” signifies hereby a water content of 30% to 150%, measured according to DIN 52182. The use of wood elements (A) having a low water content is likewise possible, preferably having a water content in the range of from 5% to 30%.

In a further embodiment, the method according to the invention may comprise a drying step.

Preferably, said drying step is performed prior to step (H4), preferably subsequent to the deformation according to step (H3).

In this embodiment, the method according to the invention is then characterized in that step (H3) comprises at least step (H3.2):
(H3.2): drying the wood element obtained in step (H3).

In a further embodiment it is possible that by means of a mechanical processing the stability of the wood element made according to the method according to the invention is further improved. Preferably by means of a mechanical treatment, a wave crest or a wave trough may be deformed such that a deepening results in the wave crest or wave trough. Preferably, this deformation, which is additionally performed to the deformation of step (H3), is performed after step (H3) or simultaneously with step (H3).

Accordingly, step (H3) may also comprise step (H3.3):
(H3.3) deforming a wave trough or a wave crest of a wave of the wavy wood element (B) such that in the wave trough and/or wave crest a deepening results at least partially.

Preferably, the deepening is a fold.

It is further possible to subject a wood element obtained in one of steps (H3) or (H4) to a further deformation.

In one further embodiment, the wood element obtained in step (H4) after cooling may be crushed. Accordingly, after step (H4), the method according to the invention may also comprise step (H5):
(H5) crushing the wood element obtained in step (H4).

In a further embodiment, the wood element obtained in step (H4) or (H5) may be subjected to a sieving step (H6). This may be then preferred if wood elements are to be adjusted to a certain size distribution, or if wood elements should be released from disturbing waste.

Accordingly the, method according to the invention may also comprise step (H6):
(H6) sieving the wood element obtained in step (H4) or step (H5).
   The Wood Elements (B) Made According to the Method According to the Invention are Different from the Wood Elements Discussed in the Above Section Background of the Invention

The wood element (A), the fibers of which have a preferred direction, preferably a single-layered wood element (A), fundamentally differs from the wood elements which are known from DE 42 01 201, respectively which are used in said method of making zigzag-shaped wood elements. Said wood elements are made from industrial waste of chipboards and fiberboards, thus from glued wood or glued wood fibers. In such wood elements, the fibers of the wood, respectively the longitudinal axis of chips, do not have a preferred direction but extend isotropically into the three space directions. Furthermore, the wood elements of DE 42 01 201 comprise, due to the raw material “wood material”, a considerable amount of glue as well as an extensive amount of short fibers. Thus, the wavy wood element (B) made according to the invention differs from the wood elements of DE 42 01 201. Unglued wavy wood elements according to the invention, for example, also have the advantage that no formaldehyde may evaporate which stems from the glues which are frequently used in the wood industry.

The wavy wood element made according to the method according to the invention is also fundamentally different from the wood elements which are disclosed in WO 2009/067344, which are subjected to a sanding step in order to make the decorative veneer having the changed grain direction. Said wood elements, which are subjected to sanding step, which removes the wave crests and the wave troughs in order to make a planar decorative veneer having a changed grain direction, must have a ratio of wave height to thickness which is less than 2:1. Otherwise, the wave crests and the wave troughs may not be removed without destroying the wood element. On contrary thereto, the wood elements (B) according to the invention must have a ratio of wave height to thickness which is 2:1 or is more than 2:1.

CH 254025 does not provide any hint that the folded wood elements disclosed in said document are subjected to a heat treatment after step (H2). Thus, said document neither discloses step (H2) nor the combination of steps (H1) to (H4) of the method according to the invention. Thus, CH 254025 does not disclose a wood element, which would correspond to the wood elements (B) of the invention. Furthermore, for making the folded wood elements of the CH 254025, high-grade veneers are necessary since in the core layer of a composite regular structures in the form of a framework are to be generated. The wood elements disclosed in said document thus may not be made from veneer waste or OSB chips as it is possible with the wood elements according to the invention. Furthermore, the use of such veneer waste or OSB chips allow for considerably saving costs compared to the high-grade veneers used in CH 254025.

DE 10 2008 022 806 does not provide any hint that the wavy wood elements disclosed in said documents are subjected to a heat treatment after step (H2). Said document thus neither discloses step (H2) nor the combination of steps (H1) to (H4) of the method according to the invention. Accordingly, DE 10 2008 022 806 does not disclose a wood element that would correspond to the wood elements (B) according to the invention. Furthermore, for making the wavy wood elements of DE 10 2008 022 806, high-grade veneers are necessary since in the core layer of a composite regular structures are to be generated. Thus, the wood elements disclosed in said documents may not be made from veneer waste or OSB chips as it is possible with the wood elements (B) according to the invention. Furthermore, the use of such veneer waste or OSB chips allow for considerably saving costs compared to the high-grade veneers used in DE 10 2008 022 806.

DE 10 2008 022 805 discloses indeed that the glued wood elements defined in said document may optionally be subjected to a heat treatment, however, step (H2) cannot be directly and unambiguously taken from said document, optionally in combination with a defined temperature range. Furthermore, the wavy wood elements of DE 10 2008 022 805 are glued, whereas the wavy wood elements (B) of the present invention are unglued. Thus, DE 10 2008 022 805 does not disclose a wood element which would correspond to the wood elements (B) according to the invention. Furthermore, for making the wavy wood elements of DE 10 2008 022 805, high-grade veneers are necessary since in the core layer of a composite regular structures are to be generated. Thus, the wood elements disclosed in said document may not be produced from veneer waste or OSB chips as it is possible with the wood elements (B) according to the invention. Furthermore, the use of such veneer waste or OSB chips allow for considerably saving costs compared to the high-grade veneers used in DE 10 2008 022 805.

BE 547 811 does not contain any hint that the folded wood elements disclosed in said documents are subjected to a heat treatment after step (H2). Thus, said document neither discloses step (H2) nor the combination of steps (H1) to (H4) of the method according to the invention. Thus, BE 547 811 does not disclose a wood element that would correspond to the wood elements (B) according to the invention. Furthermore, for making the folded wood elements of BE 547 811, high-grade veneers are necessary since in the core layer of a composite regular structures are to be generated. Thus, the wood elements disclosed in said document may not be made from veneer waste or OSB chips as it is possible with the wood elements (B) according to the invention. Furthermore, the use of such veneer waste or OSB chips allow for considerably saving costs compared to the high-grade veneers used in BE 547 811.

EP 1 923 209 discloses that the wave form of the wavy or zigzag-shaped intermediate layer, which is disclosed in said document, may be imprinted by pressure and temperature, however, step (H2) cannot be directly and unambiguously taken from said document, let alone step (H2) in combination with a defined temperature range. Furthermore, the wavy wood materials of the EP 1 923 209 are glued, whereas the wavy wood elements (B) of the present invention are unglued. Thus, EP 1 923 209 does not disclose a wood element which would correspond to the wood elements (B) according to the invention.

WO 2013/164100 A1 does not disclose a heat treatment in the manufacture of the wood elements defined in said document, which would correspond to step (H2) of the present invention. Thus, said document also does not disclose the combination of steps (H1) to (H4) of the method according to the invention. Thus, WO 2013/164100 A1 also does not disclose a wood element which would correspond to the wood elements (B) according to the invention.

### Second Aspect of the Invention: Wavy Wood Element

In a second aspect, the invention relates to a wavy wood element (B) as such.

Accordingly, in one embodiment, the invention relates to a wavy wood element, the surface of which is at least partially coated with lignin, characterized in that it is obtainable according to a method as defined in the first aspect of the invention. The term “coated” signifies that congealed or solidified lignin is at least partially on a portion of the surface of the wood element, or that at least a portion of the surface of the wood element comprises lignin.

In a further embodiment, the invention relates to a wavy wood element, the surface of which is at least partially coated with lignin, characterized in that the ratio of the wave height to the thickness of the wavy wood element is 2:1 or is more than 2:1; wherein the term “thickness” signifies the shortest distance between an upper side and the respective lower side of the wavy wood element, and the term “wave height” signifies the shortest distance between two imaginary planes which run in parallel to one another, between which the wavy wood element may be arranged such that the waves are arranged between said planes; and wherein the wood element consists of unglued wood or unglued wood fibers.

Various embodiments of the wavy wood elements are defined above in the first aspect of the invention.

In one embodiment, the wave of the wavy wood element comprises a positive-half wave, respectively a negative half-wave, only.

In one embodiment, the wave of the wavy wood element comprises at least one positive and one negative half-wave.

In one embodiment, the wave of the wavy wood element comprises at least two positive half-waves but no negative half-wave.

In one embodiment, the wavy wood element comprises at least two adjoining platelet-shaped regions, which form between them a common edge, wherein
(a) said platelet-shaped regions are planar regions, and the edge between said planar regions is a planar region; or
(b) said platelet-shaped regions are curved regions, and the edge between said planar regions is a curved region; or
(c) said platelet-shaped regions are curved regions, and the edge between said curved regions is a straight line; or
(d) said platelet-shaped regions are curved regions, and the edge between said curved regions is a planar region.

In one embodiment, the wave of the wavy wood element
(a) has at least partially the form of a trapezoidal wave; or has in longitudinal section at least partially the form of a trapezoidal wave or comprises repeating units of a trapezoid; or
(b) has at least partially the form of a sine wave; or has in longitudinal section at least partially the form of a sine wave or comprises repeating units of a sine function; or
(c) has at least partially the form of a rectangular wave; or has in longitudinal section at least partially the form of a rectangular wave or comprises repeating units of a rectangle; or
(d) has at least partially the form of a triangle wave; or has in longitudinal section at least partially the form of a triangle wave or comprises repeating units of a triangle; or
(e) has at least partially the form of a sawtooth wave; or has in longitudinal section at least partially the form of a sawtooth wave or comprises repeating units of a sawtooth.

### Third Aspect of the Invention: Use of a Wood Element According to the Invention

In a third aspect, the invention relates to the use of a wood element as defined in the second aspect.

Due to the high load capacity of the wavy wood elements according to the invention, said wood elements may advantageously be used for making a core layer for a multi-layer composite or for making a multi-layer composite.

Preferably relatively big wavy wood elements according to the invention may be crushed for the manufacture of a core layer, preferably in step (H5).

Apart from said uses, which are explained in more detail in the fourth and fifth aspect of the invention, further uses are possible.

The wavy wood element according to the invention may also be used as shoe insole or as part of a shoe sole. Such a sole has the particular advantage of good elastic properties while simultaneously providing for good aeration of the foot bed. A wood element according to the invention having a length of 290 mm and a width of 81 mm, which corresponds to the area of shoe size EU 45, and which has about 40 complete waves, is suitable to carry a load of about 2,000 kg without being broken or flattened.

In a further embodiment, the wavy wood element may be used as wall paper. The sound insulating and heat insulating properties of the wavy surface of such a wall paper have to be outlined.

In a further embodiment, the wood element according to the invention may be used for sound insulation or heat insulation.

### Fourth Aspect of the Invention: Core Layer

In a fourth aspect, the invention relates to a core layer which comprises at least one wavy wood element as defined in the second aspect.

The term “core layer” signifies a layer which has a loosened structure, thus comprising cavities. According to the invention, the core layer comprises at least one wavy wood element according to the invention. Preferably, the wavy wood element has at least one wave crest (crest) and one wave trough.

If the core layer comprises several wavy wood elements according to the invention, then said wood elements are preferably arranged in the core layer such that a wave trough of a non-planar wood element contacts a wave crest of another non-planar wood element.

Preferably, the wavy wood elements are arranged in the core layer such that a wave trough of a wavy wood element contacts a wave crest of another wavy wood element in an angle which is different from zero.

The term “that a wave trough of a wavy wood element contacts a wave crest of another wavy wood element in an angle which is different from zero” signifies that an imaginary straight line which is on the wave crest, and which represents the shortest distance between the sideward borders of a wave crest, crosses an imaginary straight line, which is in the wave trough, and which represents the shortest distance between the sideward borders of the wave trough, in an angle which is different from zero.

The term “angle which is different from zero” includes that the angle is neither 180° nor 360°.

At the point of contact or crossover point of wave crest with wave trough, the two wavy elements are connected to one another. A suitable connecting means is preferably an adhesive. Suitable adhesives are known in the prior art.

The term “adhesive” comprises the term “glue”.

Wavy wood elements can be present in the core layer, which may be the same or which may be different from one another.

The wavy wood elements can be arranged in the core layer regularly or randomly. Preferably, they are arranged randomly.

If the wood elements (B) are arranged randomly in the core layer, due to the random arrangement in the core layer and apart from wood elements, which are arranged such that a wave trough of a wavy wood element crosses a wave crest of another wavy wood element in an angle which is different from zero, also wood elements may be present, which are arranged such that a wave trough of a wavy wood element crosses a wave crest of another wavy wood element in an angle which is 0°, 180°, or 360°.

In one embodiment, it is also possible that apart from the wavy wood elements according to the invention, which are connected to each other according to the invention, in the core layer also wavy wood elements (B) according to the invention are connected to planar or non-planar wood elements, preferably with one or more wood elements (A).

The core layer may be made according to a method, which comprises at least steps (K1) and (K2):
(K1) providing wavy wood elements (B) which comprise at least one wave crest (crest) or a wave trough or a wave crest and a wave trough;
(K2) arranging the wood elements (B) from step (K1) such that a wave trough of a wavy wood element (B) contacts a wave crest of another wavy wood element (B), preferably crosses same in an angle which is different zero;
(K3) connecting the wave trough to the wave crest from step (K2)

In one embodiment, steps (K1) and (K2) are performed simultaneously, preferably by means of randomly spreading the wood elements.

In one embodiment, the connecting in step (K3) is performed by means of an adhesive.

In another embodiment, at the point of contact, respectively at the overcrossing point of the wave trough with a wave crest, the two elements which may be the same or which may be different from one another may be fixedly connected to one another by means of planar elements selected from: wood, paper, metal, plastics, and two or more thereof.

In one embodiment, the arranging of the elements in step (K2) may be performed by means of aligning the wood elements, which preferably is performed automatically.

The connecting in step (K3) may be facilitated by means of applying pressure, which preferably is in the range of from 0.02 MPa to 1.5 MPa, more preferred in a range of from 0.01 MPa to 1.0 MPa.

Each of steps (K1) to (K3) may be performed in presence of a cover layer. Preferably, then the method is performed such that the wood elements, which are provided with an adhesive, are provided on the cover layer according to step (K1), and are aligned on said cover layer according to step (K2).

Preferably, this arrangement is covered by means of a further cover layer and is pressed. Thereby, a multi-layer composite is generated comprising two cover layers and in-between a core layer comprising wavy wood elements (B) according to the invention.

By means of targetedly distribution of wood elements (B), also regions having a higher or lower density compared to other regions of the core layer may be generated in the core layer, depending on the requirements to the core layer. Thereby, the density profile of the core layer may be targetedly adjusted. For this, also different wood elements, for example wood elements which differ with respect to their wave form and/or the wave height, may be used.

Accordingly, in one embodiment, step (K2) comprises step (K2.1):
(K2.1): distributing wood elements (B) such that in the core layer also regions are generated having a higher or lower density of wood elements compared to other regions of the core layer.

In one embodiment, also different wood elements such as wood elements which are different with respect to their wave form and/or the wave height may be used.

### Fifths Aspect of the Invention: Multi-Layer Composite

In a fifth aspect, the invention relates to a multi-layer composite comprising at least one cover layer and at least one wavy wood element as defined in the second aspect, or comprising a cover layer and the core layer as defined in the fourth aspect.

The term “multi-layer composite” signifies a composite made from at least one core layer and at least one cover layer.

The term “cover layer” signifies a layer of a material which preferably serves as carrier for the core layer. According to the invention, the cover layer is arranged such that it covers at least partially the core layer and is in fixed communication with said core layer. The core layer may also be covered at least partially by at least two cover layers and may be in fixed communication with said cover layers. Preferably, then the core layer is positioned between the two cover layers.

The term “covered at least partially” includes that the cover layer may cover the core layer completely.

The cover layer may comprise a material selected from: veneer, wood board, chipboard, fiberboard, medium-density fiberboard (MDF), high-density fiber board (HDF), plywood board, plastic board, plasterboard, metal sheet, fiber cement board, high pressure laminate (hpl) board, continuous pressure laminate (cpl) board, mineral organic composite (e.g. made from minerals and polymers such as gibbsite and polymethacrylate), and combinations of two or more thereof.

According to the invention, the multi-layer composite according to the invention may be made according to a method which comprises at least steps (M1) and (M2):
(M1) arranging at least one wavy wood element (B) on the cover layer;
(M2) connecting the wood element (B) with the cover layer by means of an adhesive; or
(M1) arranging the core layer as defined in the fourth aspect on the cover layer;
(M2) connecting the core layer to the cover layer by means of an adhesive.

The multi-layer composite may have a density in the range of from 250 kg/m³ to 550 kg/m³, preferably 300 kg/m³ to 500 kg/m³, further preferred 350 kg/m³ to 450 kg/m³.

The bending stiffness of the multi-layer composite according to the invention is considerably higher than that of chipboards or OSB panels of comparable density. It may be a multiple of the bending stiffness which is known from chipboards and OSB panels.

Moreover, the core layer according to the invention, respectively the multi-layer composite according to the invention comprising said core layer, provide for an advantageous less pronounced swelling in thickness when subjected to moisture compared to traditional boards such as chipboards or OSB panels or traditional lightweight building boards. It is believed that this is due to the loosened structure of the core layer.

### Sixth Aspect of the Invention: Use

In a sixth aspect, the invention relates to the use of a core layer as defined in the fourth aspect of the invention, or a multi-layer composition as defined in the fifth aspect, for making furniture, doors and gates, panels, floors, shelves, packaging for transportation, indoor extensions, as well as in vehicle and ship construction, for fields of the constructive timber construction, and for sound and heat insulation.

### REFERENCE NUMERALS

1, 2, 3, 4 wavy wood elements (half-waves)
5, 6, 7, 8, 9, 10, 11, 12, 15 wavy wood elements
20, 30 adjoining regions
1′, 2′, 3′, 4′ edges between adjoining regions 20 and 30
40 wave trough of wavy wood element 13
50 wave crest of wavy wood element 13
70 contact point between wave trough 40 and wave crest 50

1. Method of making a wavy wood element (B) from a planar or non-planar wood element (A), wherein the method comprises at least steps (H1) to (H4):
(H1) providing a planar or non-planar wood element (A), which comprises fibers and lignin on or between said fibers;
(H2) heating the wood element (A) to a temperature which is sufficient to soften or melt at least a part of the lignin; preferably the temperature is at least 80° C., in particular the temperature is in the range of from 80° C. to 400° C.;
(H3) deforming the wood element heated in step (H2) such that a wavy wood element (B) is formed;
(H4) cooling the wood element deformed in step (H3);
characterized in that the deforming in step (H3) is performed such that the ratio of the wave height to the thickness of the wavy wood element (B) is 2:1 or is more than 2:1;
wherein the term “thickness” signifies the shortest distance between an upper side and the respective lower side of the wavy wood element (B), and the term “wave height” signifies the shortest distance between two imaginary planes which run in parallel to one another, between which the wavy wood element (B) may be arranged such that the waves are positioned between said planes;
and wherein the wood element (A) consists of unglued wood or unglued wood fibers.

2. Method according to claim 1, wherein in step (H2) wood element (A) is heated to a temperature in the range of from 100° C. to 380° C., or to a temperature in the range of from 120° C. to 360° C., or to a temperature in the range of from 150° C. to 350° C.; and/or wherein in step (H4) the wood element deformed in step (H3) is cooled down to ambient temperature, preferably to a temperature in the range of from 0° C. to 40° C., further preferred 10° C. to 30° C.

3. Method according to claim 1, wherein in step (H2) wood element (A) is heated to a temperature in the range of from 230° C. to 400° C., or from 240 to 400° C., or from 250 to 400° C., or from 260 to 400° C., or from 230° C. to 350° C., or from 240 to 350° C., or from 250 to 350° C., or from 260 to 350° C.; and/or wherein in step (H4) the wood element deformed in step (H3) is cooled down to ambient temperature, preferably to a temperature in the range of from 0° C. to 40° C., further preferred 10° C. to 30° C.

4. Method according to any one of the preceding claims, wherein the deforming in step (H3) is performed by means of a profile tool such that the wave of the wavy wood element (B) comprises one positive, respectively one negative half-wave, only.

5. Method according to any one of claims 1 to 3, wherein the deforming in step (H3) is performed by means of a profile tool such that the wave of the wavy wood element (B) comprises at least one positive and one negative half-wave.

6. Method according to any one of claims 1 to 3, wherein the deforming in step (H3) is performed by means of a profile tool such that the wave of the wavy wood element (B) comprises at least two positive half-waves but no negative half-wave.

7. Method according to any one of claims 1 to 5, wherein the deforming in step (H3) is performed by means of a profile tool such that the wavy wood element (B) comprises in longitudinal section repeating units in the form of a trapezoid; or repeating units in the form of a sine function.

8. Method according to any one of the preceding claims 1 to 5, wherein the deforming in step (H3) is performed by means of a profile tool such that the wavy wood element (B) has at least partially the form of a trapezoidal wave, or at least partially the form of a sine wave, or at least partially the form of a rectangular wave, or at least partially the form of a triangle wave, or at least partially the form of a sawtooth wave, or the wavy wood element (B) has at least partially at least two different of these forms.

9. Method according to any one of the preceding claims, wherein in step (H1) a wood element (A) is utilized, the fibers of which have a preferred direction, and the deforming in step (H3) is performed such that
the fiber direction of the wavy wood element (B) does not run in parallel to a wave trough or wave crest; or
the fiber direction of the wavy wood element (B) runs perpendicularly to a wave trough or wave crest.

10. Method according to any one of the preceding claims, wherein the ratio of wave height to thickness is in the range of equal or more than 2.0:1 to 30:1, or equal or more than 2.0:1 to 15:1, or 3:1 to 10:1, or 4:1 to 8:1, or 5:1 to 6:1.

11. Method according to any one of the preceding claims, wherein the thickness of the wavy wood element (B) is in the range of from 0.1 mm to 5 mm, and the wave height is in the range of from 1 mm to 20 mm; or the thickness of the wavy wood element (B) is in the range of from 0.2 mm to 3.5 mm and the wave height is in the range of from 2 mm to 12 mm; or the thickness of the wavy wood element (B) is in the range of from 0.2 mm to 2 mm and the wave height is in the range of from 2 mm to 8 mm.

12. Method according to any one of the preceding claims, further comprising at least one of the following steps (H3.1), (H3.2), (H3.3), (H5) and/or (H6):
(H3.1) directing the wood element (A) heated in step (H2) between at least one pair of profile rollers, the rollers of which rotate in opposite direction;
(H3.2) drying the deformed wood element obtained in step (H3);
(H3.3) deforming a wave trough or a wave crest of a wave of the wavy wood element (B) such that in the wave trough and/or in the wave crest a deepening is at least partially formed, preferably a fold;
(H5) crushing the wood element obtained in step (H4);
(H6) sieving the wood element obtained in step (H4) or step (H5).

13. Method according to any one of the preceding claims, wherein wood element (A) is a veneer.

14. Method according to any one of the preceding claims, wherein wood element (A) is an OSB chip having a length of more than 50 mm and a thickness of less than 2 mm.

15. Method according to claim 14, wherein wood element (A) is an OSB chip having a length of from 75 to 100 mm, a width of from 5 to 30 mm, and a thickness of from 0.3 to 0.65 mm; or
having a length of from 75 to 150 mm, a width of from 15 to 25 mm, and a thickness of from 0.3 to 0.7 mm; or
having a length of from 75 to 150 mm, a width of from 10 to 35 mm, and a thickness of from 0.6 to 0.8 mm.

16. Method according to claims 14 to 15, wherein wood element (A) is an OSB chip having a length of from 40 to 80 mm, and a width of from 4 to 10 mm, wherein the ratio of length to width is at least 5:1.

17. Wavy wood element, the surface of which is at least partially coated with lignin, characterized in that it is obtainable according to a method as defined in any one of claims 1 to 16.

18. Wavy wood element, the surface of which is at least partially coated with lignin, characterized in that the ratio of the wave height to thickness of the wavy wood element is 2:1 or is more than 2:1;
wherein the term “thickness” signifies the shortest distance between an upper side and the respective lower side of the wavy wood element, and the term “wave height” signifies the shortest distance between two imaginary planes which run in parallel to one another, between which the wavy wood element may be arranged such that the waves are positioned between said planes;
and wherein the wood element (A) consists of unglued wood or unglued wood fibers.

19. Wavy wood element according to claim 17 or 18, wherein the wave of the wavy wood element comprises a positive-half wave, respectively a negative half-wave, only.

20. Wavy wood element according to claim 17 or 18, wherein the wave of the wavy wood element comprises at least one positive and one negative half-wave.

21. Wavy wood element according to claim 17 or 18, wherein the wave of the wavy wood element comprises at least two positive half-waves but no negative half-wave.

22. Wavy wood element according to any one of claims 17 to 21, wherein said wavy wood element comprises at least two adjoining platelet-shaped regions, which form between them a common edge, wherein
(a) said platelet-shaped regions are planar regions, and the edge between said planar regions is a planar region; or
(b) said platelet-shaped regions are curved regions, and the edge between said planar regions is a curved region; or
(c) said platelet-shaped regions are curved regions, and the edge between said curved regions is a straight line; or
(d) said platelet-shaped regions are curved regions, and the edge between said curved regions is a planar region.

23. Wavy wood element of any one of claims 17 to 22, wherein the wave of the wavy wood element
(a) has at least partially the form of a trapezoidal wave; or has in longitudinal section at least partially the form of a trapezoidal wave or comprises repeating units of a trapezoid; or
(b) has at least partially the form of a sine wave; or has in longitudinal section at least partially the form of a sine wave or comprises repeating units of a sine function; or
(c) has at least partially the form of a rectangular wave; or has in longitudinal section at least partially the form of a rectangular wave or comprises repeating units of a rectangle; or
(d) has at least partially the form of a triangle wave; or has in longitudinal section at least partially the form of a triangle wave or comprises repeating units of a triangle; or
(e) has at least partially the form of a sawtooth wave; or has in longitudinal section at least partially the form of a sawtooth wave or comprises repeating units of a sawtooth.

24. Use of a wood element as defined in any one of claims 17 to 23,
as shoe insole or as part of a shoe sole or for making a shoe insole or for making a shoe sole; or
as wall paper or for making a wall paper; or
as core layer or for making a core layer; or
for making a multi-layer composite, in particular a lightweight building board; or
for sound insulation; or
for heat insulation.

25. Core layer, at least comprising a wavy wood element as defined in any one of claims 17 to 23: or
core layer comprising a multitude of wavy wood elements as defined in any one of claims 17 to 23, which may be the same or which may be different from one another, wherein in the core layer also regions may be present having a higher or lower density of wood elements compared to other regions of the core layer.

26. Core layer according to claim 25, comprising at least two wavy wood elements, which may be the same or which may be different from one another, wherein a wave trough of a wavy wood element contacts a wave crest of another wavy wood element, wherein wave trough and wave crest are connected at the point of contact by means of an adhesive.

27. Core layer according to claim 26, wherein a wave trough of a wavy wood element crosses a wave crest of another wavy wood element in an angle which is different from zero.

28. Multi-layer composite, in particular lightweight building board, wherein the multi-layer composite comprises at least one cover layer and at least one wavy wood element according to any one of claims 17 to 23, which is connected to the cover layer by means of an adhesive; or
wherein the multi-layer composite comprises at least one cover layer and a core layer according to any one of claims 25 to 27, wherein the core layer is connected to the cover layer by means of an adhesive.

29. Use of a core layer as defined in any one of claims 25 to 27, or use of a multi-layer composite as defined in claim 28, for the manufacture of furniture, doors and gates, panels, floors, shelves, packaging for transportation, indoor extensions, as well as in vehicle and ship construction, for fields of the constructive timber construction, and for sound and heat insulation.
